(19) United States
(12) Patent Application Publication
(10) Pub. No.: US 2015/0277137 A1
(43) Pub. Date: Oct. 1, 2015

(54) SPECKLE FREE LASER PROJECTION

(71) Applicant: OPTOTUNE AG, Dietikon (CH)

(72) Inventors: Manuel Aschwanden, Allenwinden (CH); Christoph Stamm, Stein am Rhein (CH); Gabriel Speziga, Giubiasco (CH)

(73) Assignee: OPTOTUNE AG, Dietikon (CH)

(21) Appl. No.: 14/436,110

(22) PCT Filed: Oct. 17, 2012
(86) PCT No.: PCT/CH2012/000236

§ 371 Date: Apr. 16, 2015

(51) Int. Cl. G02B 27/48; G02B 3/00; G03B 21/20; G03B 21/14

(52) U.S. Cl. CPC G02B 27/48; G03B 21/142; G02B 3/0006; G03B 21/2033; G03B 21/2066; G03B 21/208

(57) ABSTRACT

An optical projection system comprising an image generating laser projector, a diffusive structure and an observer is described. The system is designed such that the light of each image pixel maintains a non-disturbed wavefront through-out the optical system preventing the creation of speckles on the image sensor of the observer.

### FIELD OF THE INVENTION

The invention relates to speckle free laser projection systems.

### BACKGROUND OF THE INVENTION

Laser speckles are one of the biggest obstacles for laser projection systems. The speckle effect is a result of the constructive and destructive interference of many waves of a coherent laser light resulting in a randomly varying intensity profile of a light projection.

When a surface is illuminated by a light wave, according to diffraction theory, each point on an illuminated surface acts as a source of secondary spherical waves. The light at any point in the scattered light field is made up of waves which have been scattered from each point on the illuminated surface. If the surface is rough enough to create path-length differences exceeding for example one wavelength, giving rise to phase changes greater than 2π, the amplitude, and hence the intensity, of the resultant light varies randomly.

In a projection system, two types of speckles can be distinguished, namely subjective and objective speckles. The objective speckles are interference patterns which are generated on a surface. In particular, objective speckles can be seen very well, when laser light has been scattered off a rough surface and then falls on another surface. For example, if a photographic plate or another 2-D optical sensor is located within the scattered light field without a lens, a speckle pattern is obtained whose characteristics depends on the geometry of the system and the wavelength of the laser. The light at a given point in the speckle pattern is made up of contributions from the whole of the scattering surface. The relative phases of these waves vary across the surface, so that the sum of the individual waves varies randomly. The pattern is the same regardless of how it is imaged, just as if it were a painted pattern.

The “size” of the speckles is a function of the wavelength of the light, the size of the laser beam which illuminates the first surface, and the distance between this surface and the surface where the speckle pattern is formed. This is the case because when the angle of scattering changes such that the relative path difference between light scattered from the center of the illuminated area compared with light scattered from the edge of the illuminated area changes by λ, the intensity becomes uncorrelated.

The second type of speckles is the so called subjective speckles. Subjective speckles are created when an observer, for example an eye or another imaging system images a coherently illuminated surface. The lenses of the imaging system focus light from different angles onto an imaging point (pixel), resulting in the interference of the light on this point. When the light has a disturbed wavefront, or the imaging system itself introduces a large disturbance of the wavefront, the light interferes positively and negatively, creating additional intensity variations.

A variety of speckle reducing methods have been known all aiming for an averaging of the speckle patterns.

US20080055698, for example, discloses an optical modulator module, including an optical modulator receiving and modulating incident lights, and outputting modulated lights as output lights, and a transparent substrate that is placed on the optical modulator, allowing the incident lights and the output lights to transmit, and that has a phase manipulating pattern formed on an area of a surface of the transparent substrate. With an optical modulator module according to the invention, laser speckles can be reduced.

US2012081786 describes despeckle elements, laser beam homogenizers and methods for despeckling. The despeckle element includes a transparent material having a first surface including a plural number of optical steps and a second surface having a plural number of microlenses. Each of the number of optical steps is in a one-to-one correspondence with at least one of the microlenses. One of the first surface and the second surface is configured to receive collimated light having a coherence length and a remaining one of the first surface and the second surface is configured to pass the collimated light separated into a plurality of beamlets corresponding to the number of microlenses. A height of each step of at least two of the optical steps is configured to produce an optical path difference of the collimated light longer than the coherence length and therefore destroying the coherence of the laser light.

Furthermore, the projection display apparatus of W02012122677 describes a speckle reducing device for a laser projection. The laser projection system comprises at least a laser light source for emitting laser light and an image generation element, such as a light deflector as a MEMS mirror or a two dimensional intensity modulating array as a digital light processor (DLP), for modulating the laser light into image light. The image light is projected onto a screen through a light outlet to form an image. The speckle reducing device utilizes at least a laser phase disturbing element disposed at a projection path of the laser light between the laser light source and the screen for the laser light passing in a reflective or transmitting mode. At least a phase disturbing pattern is arranged on a surface of the phase disturbing element in order to generate uneven phase change in the laser light passing through the phase disturbing pattern, so that at last the coherence length of the image light emitted from the screen is reduced to effectively reduce speckle.

All prior art systems have the drawback that they rely on the principle of destroying the coherence of the laser light and therefore actively reducing speckles. This is particularly difficult to achieve in point scanning systems, since the perturbation for each image pixel has to be created in an extremely short time.

### OBJECT AND SUMMARY OF THE INVENTION

It is an object of the invention to propose a different approach for speckle free projection systems. Instead of removing speckles by using a coherence destroying averaging approach, this invention aims to create a speckle free image by maintaining excellent coherence and a non-disturbed wavefront for each image pixel throughout the entire projection systems up to the observer.

To this end, the speckle free projection system according to the invention comprises:
A coherent laser light creating a non-disturbed wavefront
A light deflector e.g. a MEMS mirror or a two dimensional intensity modulating array such as a digital light processor (DLP) or a liquid crystal on silicon (LCOS), or a transmission based light modulator, e.g. LCD, for modulating the laser light into an image light
A diffusive structure maintaining the non-disturbed wavefront for each pixel e.g. a microlens array
And an observer having an imaging optics

The coherent laser light is directed onto the light deflector, which deflects the light to create an image. The wavefront of each pixel of the image remains non-disturbed and if imaged by an observer, e.g. an eye, neither objective nor subjective speckles are observed. For most practical projection system, however, it is not possible to send the laser light directly into the observers imaging system but a diffusive screen is normally required to increase the possible viewing angles. Unfortunately, when coherent light is sent for example through a random diffuser, the wavefront of the laser light is at least partially disturbed and when imaged by the imaging optics of an observer, subjective speckles are created on the imaging sensor. To prevent these unwanted subjective speckles a diffusive structure that does not destroy the wavefront of the laser light while diverging it, such that the image can be seen from multiple viewing angles, is required. One example of such a diffusive structure is a microlens array that has for example one lens per projected image pixel. When such a pixel is imaged by the observer, no speckles are created in this pixel. Other structures such as micro-mirrors or other structures that do not disturb the wavefront of the light are also possible. The main advantage of such wavefront maintaining structures is the fact that both subjective and objective speckles are prevented to occur without the need of any dynamic system.

In a preferred embodiment, the wavefront maintaining structure is a microlens array made out of an injection molded plastic or polymer. In another embodiment, the diffusive screen is a mirror consisting of micro-mirrors.

The invention also relates to systems in which the light is pre-shaped in front or after the wavefront maintaining diffusive structure.

An embodiment of the present invention may include a light deflector e.g. a MEMS mirror or a two dimensional intensity modulating array such as a digital light processor (DLP), liquid crystal on silicon (LCOS), or a transmission based light modulator for modulating the laser light into an image light

Detailed explanations and other aspects of the invention will be given below.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 depicts a first embodiment of an optical system according to the invention,

FIG. 2 depicts a second embodiment of an optical system according to the invention,

FIG. 3 depicts a third embodiment of an optical system according to the invention,

FIG. 4 depicts a forth embodiment of an optical system according to the invention

### DETAILED DESCRIPTION OF EMBODIMENTS

Definitions

The term “non-disturbed wavefront” is generally used to describe a light wave that has a not or only minimally perturbed wavefront. In other words, all parts of the light wave, which are focused by an imaging system on one area, have the same or very similar phases. In particular, the phase difference between the interfering light waves is smaller than one wavelength and in particular smaller than 0.25 wavelengths.

The invention utilizes the fact that lenses maintain a non-disturbed wavefront of laser light and that light with a non-disturbed wavefront does not generate subjective speckles when focused by an imaging system. The present invention can be implemented in a variety of forms. In the following, we describe some of these systems.

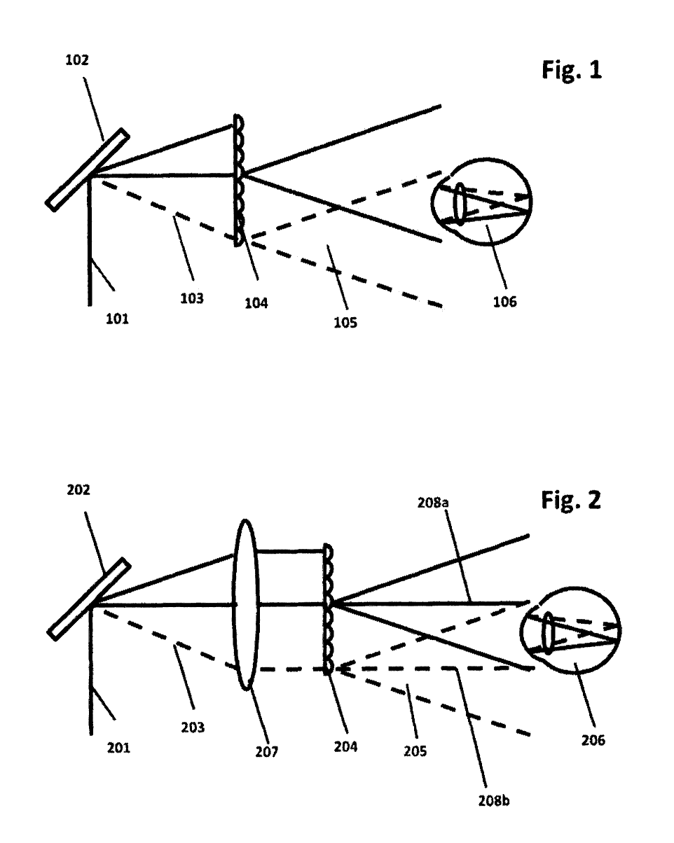

One possible embodiment of the present invention is shown in FIG. 1. This embodiment comprises:

A coherent light source 101 creating a non-disturbed wavefront. This can be a monochromatic or polychromatic source generated by one laser or multiple laser sources. An image generating light deflector 102 e.g. a scanning mirror, which deflects the light in one or two dimensions generating a projection image 103. When the surface quality of the scanning mirror is good, the wavefront of the light of the projection image remains non-disturbed. The generated image is then directed onto a diffusive structure 104, which maintains the non-disturbed wavefront for each pixel. One example for such a structure is a microlens array. The microlens array ideally has one microlens per pixel of the projection image. In this case, each pixel is matched to one microlens. Depending on the focal length of the microlenses, the light of each pixel is diverged into a particular angle creating a diffusive image 105. The diffusive image 105 is then imaged by an observer 106 e.g. an eye. When the imaging system of the observer focuses onto the surface of the diffusive structure 104 an image of the projection image is created on the image sensor of the observer. Since the microlenses maintain the non-disturbed wavefront of the light of each pixel, each pixel is projected onto the retina without creating speckles. Therefore, the system described in the embodiment allows the observer to see a speckle free image from many viewing angles.

Advantageously, the diffusive structure 104 is manufactured using one of the following processes:
a) Casting, in particular injection molding/mold processing
b) Imprinting, e.g. by hot embossing nanometer-sized structures
c) Etching (e.g. chemical or plasma)
d) Sputtering
e) Hot embossing
f) Soft lithography (i.e. casting a polymer onto a pre-shaped substrate)
g) Self-assembly: Magnetic or chemical self-assembly (see e.g. “Surface tension-powered self-assembly of microstructures—the state-of-the-art”, R. R. A. Syms, E. M. Yeatman, V. M. Bright, G. M. Whitesides, Journal of Microelectromechanical Systems 12(4), 2003, pp. 387-417)
h) Electro-magnetic field guided pattern forming (see e.g. “Electro-magnetic field guided pattern forming”, L. Seemann, A. Stemmer, and N. Naujoks, Nano Lett., 7 (10), 3007 - 3012, 2007. 10.1021/n10713373.

The light deflector 102 may consist of a
a) Scanning mirror
b) Digital light processor (DLP)
c) Liquid crystal on silicon (LCOS)
d) Dynamic diffractive optics (e.g. Holographic structure)
e) Transmission based light modulator, e.g. LCD

The diffusive structure 104 may consist of a
a) Refractive structure
b) Diffractive structure
c) Holographic structure
d) Reflective structure

The surface of the diffusive structure 104 can e.g. be coated with:
a) an antireflection coating
b) a reflective coating
c) a color filter coating

The material for the diffusive structure 104 can e.g. comprise or consist of:
a) Gels (Optical Gel OG-1001 by Liteway),
b) Elastomers (TPE, LCE, Silicones e.g. PDMS Sylgard 186, Acrylics, Urethanes)
c) Thermoplaste (ABS, PA, PC, PMMA, PET, PE, PP, PS, PVC, . . . )
d) Duroplast
e) Glass
f) Metal
g) Other Materials with characteristic optical properties (ceramics, liquids)
h) combinations thereof

A second embodiment of the present invention is shown in FIG. 2. This embodiment comprises:

A coherent light source 201 creating a non-disturbed wavefront. This can be a monochromatic or polychromatic source generated by one laser or multiple laser sources. An image generating light deflector 202 e.g. a scanning mirror, which deflects the light in one or two dimensions, generating a projection image 203. When the surface quality of the scanning mirror is good, the wavefront of the light of the projection image remains non-disturbed. The generated image is then directed onto a collimation optics 207 which directs the non-disturbed light onto a diffusive structure 204, in particular a microlens array.

The microlens array ideally has one microlens per pixel of the projection image. In this case, each pixel is matched to one microlens. Depending on the focal length of the microlenses, the light of each pixel is diverged into a particular angle creating a diffusive image 205. The diffusive image 205 is then imaged by an observer 206 e.g. an eye. When the imaging system of the observer is focused onto the surface of the diffusive structure 204 an image of the projection image is created on the image sensor of the observer. Since the microlenses maintain the non-disturbed wavefront of the light of each pixel, each pixel is projected onto the retina without creating speckles. Therefore, the system described in the embodiment allows the observer to see a speckle free image from many viewing angles.

The advantage of this embodiment is the fact that the chief rays 208a and 208b of the incidence angle of the light of each image pixel onto the microlens array is substantially the same, resulting in an homogeneous light intensity distribution at each possible angular position of the observer 206.

The collimation optics 207 may consist of a
a) refractive lens
b) diffractive lens
c) Fresnel lens
d) Lens stack
e) Mirrors
f) a combination of all the above.

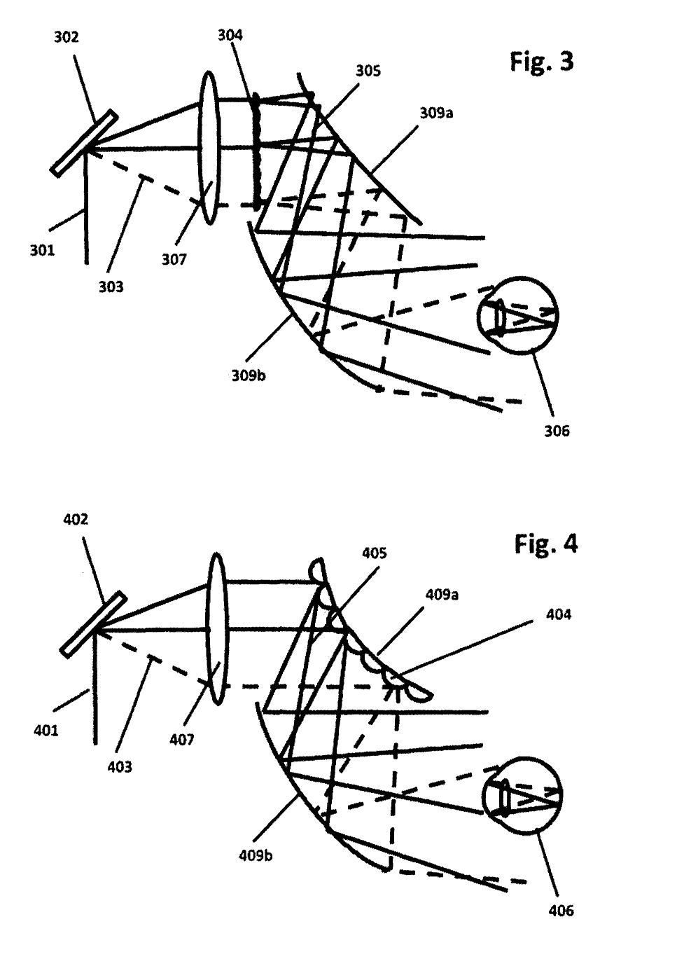

A third embodiment of the present invention is shown in FIG. 3. This embodiment substantially corresponds to the second embodiment, with the exception that a magnifying optics 309 is introduced after the diffusive structure 304 to adjust the size of the observed image. The magnifying optics can be a lens system or a mirror system or a combination of both.

A forth embodiment of the present invention is shown in FIG. 4. This embodiment substantially corresponds to the third embodiment, with the exception that the diffusive structure 404 is integrated into the magnifying optics 409.

The invention is not limited to the microlens array described for the diffusive structure. Indeed, other structures could be defined for diffusing the light, while maintaining the non-disturbed wavefront of the light of each pixel and preventing any diffraction artifacts.

The invention also relates to systems in which the light deflector can be a two dimensional intensity modulating array such as a digital light processor (DLP) or an LCOS instead of a scanning mirror.

Some applications:

The optical system can be used in a large variety of applications, such as:
Macro- and micro-projectors for home or professional displays
Head-up displays
Laptop/mobile projectors
TV-projectors
Business projectors
Head-mounted displays

While there are shown and described presently preferred embodiments of the invention, it is to be distinctly understood that the invention is not limited thereto but may be otherwise variously embodied and practiced within the scope of the following claims.

1. An optical system, comprising: a coherent light source (101, 201, 301, 401) a light deflector (102, 202, 302, 402) emitting a projection image (103, 203, 303, 403) with a non-disturbed wavefront for each image pixel, a diffusive structure (104, 204, 304, 404) , which maintains the non-disturbed wavefront and an observer (106, 206, 306, 406), imaging the image created on the diffusive structure (104, 204, 304, 404).

2. The optical system as claimed in claim 1, wherein the diffusive structure (104,204, 304, 404) is a microlens array.

3. The optical system as claimed in claim 1, wherein a collimation optics (207, 307, 407) is redirecting the projection image (203) onto the diffusive structure such that the chief rays (208) for each image pixel are incident onto the diffusive structure (204) under a substantially similar angle.

4. The optical system according to claim 3, wherein the collimation optics (207, 307, 407) consists of a refractive, diffractive or reflective optical element.

5. The optical system according to claim 1, wherein a magnifying optics (309, 409) is changing the size of the image on the diffusive structure (304, 404), observed by the observer (306, 406).

6. The optical system as claimed in claim 5, wherein the diffusive structure (304, 404), is integrated into the magnifying optics (309, 409).

7. The optical system according to claim 1, wherein said diffusive structure (104, 204, 304, 404) is made of polymer, plastic, glass, crystal, or metal.

8. The optical system according to claim 1, wherein the disturbance of the wavefront of each image pixel is less than one wavelength, in particular less than 0.25 wavelengths throughout the optical system.

9. The optical system according to claim 1, wherein said diffusive structure (104, 204, 304, 404) is made of polymer, plastic, glass, crystal, or metal.

10. The optical system according to claim 1, wherein the structure of the diffusive structure (104, 204, 304, 404) has the same pitch as the pixel size of the projection image (103,203,303,403).

11. The optical system according to claim 1, wherein the diffusive structure (104, 204, 304, 404) is reflective or transmissive.

12. The optical system according to claim 1, characterized in that wherein the structure of the diffusive structure (104, 204, 304,404) is periodic or random.

13. The optical system according to claim 1, wherein the diffusive structure (104, 204, 304,404) is at least refractive, diffractive or holographic.

14. The optical system according to claim 1, wherein the magnifying optics (309, 409) is at least transmissive, diffractive or reflective.

15. The optical system according to claim 1, wherein the projection image (103, 203, 303, 403) is generated by a scanning mirror based laser projector or a two dimensional intensity modulating array based laser projector.
